(19) United States
(12) Patent Application Publication
(10) Pub. No.: US 2016/0128506 A1
(43) Pub. Date: May 12, 2016

(54) APPRARATUS FOR PRODUCING GERMANIUM SPRING WATER

(71) Applicant: Soo Ryong Jung, Diamond Bar, CA (US)

(72) Inventor: Soo Ryong Jung, Diamond Bar, CA (US)

(21) Appl. No.: 14/937,626

(22) Filed: Nov. 10, 2015

Related U.S. Application Data
(60) Provisional application No. 62/077,754, filed on Nov. 10, 2014.

(51) Int. Cl. A47J 31/40; A47J 31/44; A47J 31/00

(52) U.S. Cl. CPC A47J 31/404; A47J 31/00; A47J 31/44

(57) ABSTRACT

A germanium hot spring water generating system may include a shell and a front cover, a water filter, a water softening unit and a mineral generating unit. A cold water inlet and a hot water inlet are disposed at a sidewall of the shell and an output channel is disposed at a lower portion thereof. The water filter, the water softening unit, and the mineral generating unit are connected in order and connected to a water inlet pipe, and a water flow control valve is disposed at a front end of the cold and hot water inlets. A first water outlet pipe and a second water outlet pipe are disposed at a bottom portion of the mineral generating unit.

### CROSS-REFERENCE TO RELATED APPLICATIONS

This application claims priority under 35 U.S.C. §119 (e) to U.S. Provisional Patent Application Ser. No. 62/077,754, filed on Nov. 10, 2014, the entire contents of which are hereby incorporated by reference.

### FIELD OF THE INVENTION

The present invention is related to an apparatus for producing hot spring water, and more particularly to an apparatus for producing hot spring water containing germanium.

### BACKGROUND OF THE INVENTION

A hot spring is a spring that is produced by the emergence of geothermally heated groundwater from the Earth's crust. The water issuing from a hot spring is heated by geothermal heat, i.e., heat from the Earth's mantle. In general, the temperature of rocks within the earth increases with depth. The rate of temperature increase with depth is known as the geothermal gradient. If water percolates deeply enough into the crust, it will be heated as it comes into contact with hot rocks. The water from hot springs in non-volcanic areas is heated in this manner.

However, if people want to enjoy the hot spring, they may have to go out to the hot spring spots, which may be crowded and may not be clean. Therefore, there remains a need for an apparatus to produce hot spring water just at patio or yard in the user's house.

### SUMMARY OF THE INVENTION

It is an object of the present invention to provide an apparatus for producing germanium hot spring water for the user to enjoy hot spring at home.

It is a further object of the present invention to provide an apparatus for producing germanium hot spring water that is easy to set up and operate.

In one aspect, a germanium hot spring water generating apparatus may include a shell, front cover and screen, wherein a cold water inlet and a hot water inlet are disposed at the sidewall of the shell and an output channel is disposed at a lower portion of the shell. On the other side of the shell has a water channel connecting to a water tank, and a power supply.

The hot spring water device further includes a water filter, water softening device, and a device to provide multiple mineral components, which are connected in order and connected to a water inlet pipe. A water flow control valve is installed at a front end of the cold and hot water inlets. The flow control valve can also serve as a temperature controller. A first water outlet pipe and a second water outlet pipe are disposed at a bottom portion of the device to provide mineral components. An electric valve is disposed at the first water outlet pipe and both sides of the electric valve have the hot spring water outlet pipe and water channel. A second electric valve is disposed at the second water outlet pipe.

The hot spring water device may have at least two material receiving spaces, each of which has a material outlet and a flow control valve. A bottom portion of the material receiving space has a material mixing chamber, a mixing rod, and an anti-leaking ball valve. At a lower portion of one side of the material mixing chamber has a water outlet pipe, an electric valve, a switch valve, a first mixed water outlet pipe to connect to the water channel, and a second mixed water outlet pipe to connect to the hot spring water outlet pipe

### BRIEF DESCRIPTION OF THE DRAWINGS

FIG. 1 illustrates a schematic view of the device for generating germanium hot spring water in the present invention.

FIG. 2 illustrates a schematic view of the system for generating germanium hot spring water in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

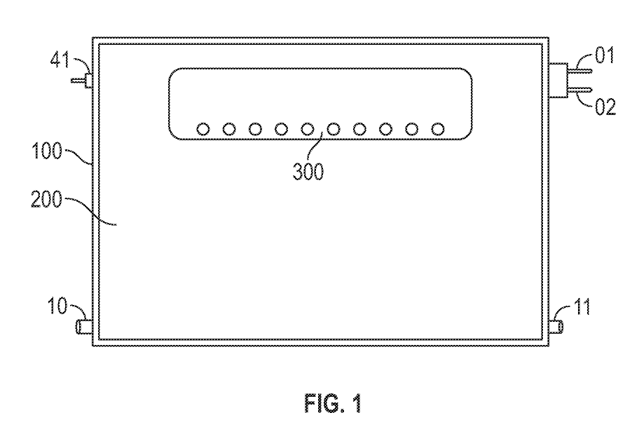

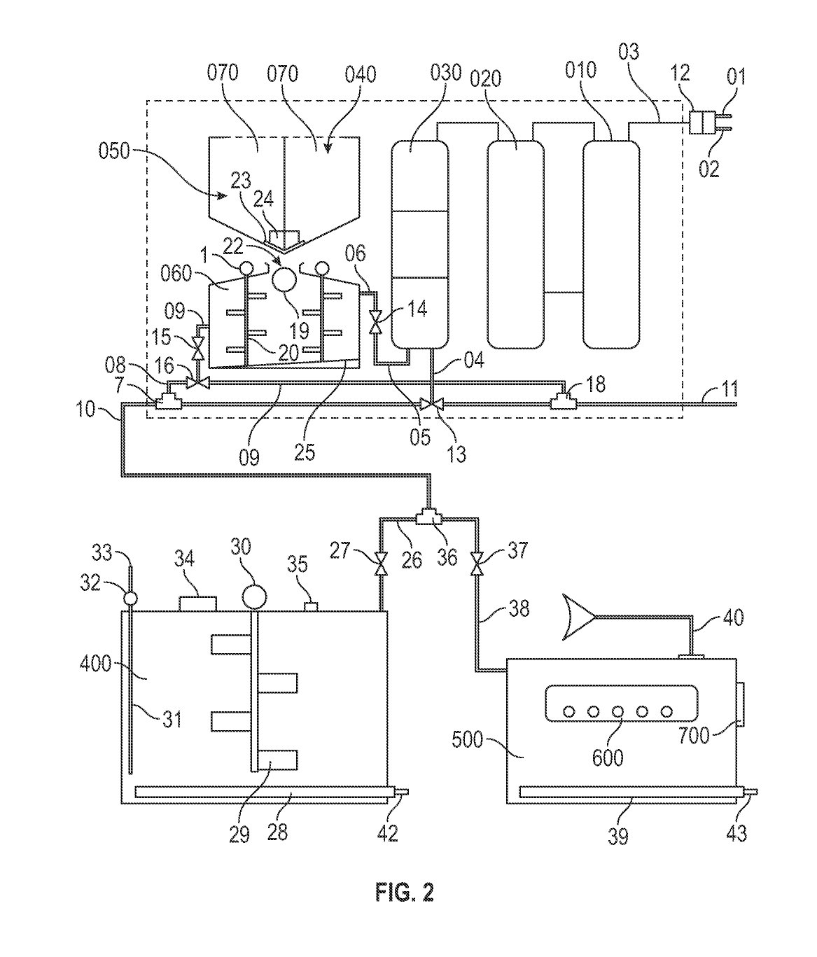

Referring to FIGS. 1 and 2, a germanium hot spring water generating apparatus may include a shell (100), front cover (200) and screen (300), wherein a cold water inlet (01) and a hot water inlet (02) are disposed at the sidewall of the shell (100) and an output channel (11) is disposed at a lower portion of the shell (100). On the other side of the shell has a water channel (10) connecting to a water tank, and a power supply (41).

The hot spring water device further includes a water filter (010), water softening device (020), and a device to provide multiple mineral components (030), which are connected in order and connected to a water inlet pipe (03). A water flow control valve (12) is installed at a front end of the cold and hot water inlets (01, 02). The flow control valve (12) can also serve as a temperature controller. A first water outlet pipe (04) and a second water outlet pipe (05) are disposed at a bottom portion of the device to provide mineral components (030). An electric valve (13) is disposed at the first water outlet pipe (04) and both sides of the electric valve (13) have the hot spring water outlet pipe (11) and water channel (10). A second electric valve (14) is disposed at the second water outlet pipe (05).

The hot spring water device may have at least two material receiving spaces (040, 050), each of which has a material outlet (23) and a flow control valve (24). At a bottom portion of the material receiving space has a material mixing chamber (060), a mixing rod (20), and an anti-leaking ball valve (19). At a lower portion of one side of the material mixing chamber (060) has a water outlet pipe (07), an electric valve (15), a switch valve (16), a first mixed water outlet pipe (08) to connect to the water channel (10), and a second mixed water outlet pipe (09) to connect to the hot spring water outlet pipe (11).

The hot spring water device may further include an external water tank (400) and an external steam box (500). The external water tank (400) has a mixed hot spring water inlet tube (26), flow control valve (27), heating unit (28), stirring unit (29), electro-mechanical unit (30), a suction pipe (31), water pump (32), water outlet pipe (33), pressure sensor (34), a gas valve (35) and a power supply (42). The external steam box (500) has a display screen (600), material receiving unit (700), mixed hot spring inlet pipe (38), flow control valve (37), power supply (43), heating unit (39), steam outlet (40) and steam pipe (41). An electrical valve (36) is disposed at the lower portion of the water outlet of the external water tank (400). It is noted that both the external water tank (400) and external steam box (500) have a water level sensing unit, temperature sensor and electricity leakage sensor.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A germanium hot spring water generating system comprising a shell and a front cover, a water filter, a water softening unit and a mineral generating unit, wherein a cold water inlet and a hot water inlet are disposed at a sidewall of the shell and an output channel is disposed at a lower portion thereof, wherein the water filter, the water softening unit, and the mineral generating unit are connected in order and connected to a water inlet pipe, and a water flow control valve is disposed at a front end of the cold and hot water inlets, wherein a first water outlet pipe and a second water outlet pipe are disposed at a bottom portion of the mineral generating unit.

2. The germanium hot spring water generating system of claim 1, wherein the mineral generating unit is configured to generate minerals including germanium.

3. The germanium hot spring water generating system of claim 1, further comprising at least two material receiving spaces, each of which has a material outlet and a flow control valve, and at a bottom portion of the material receiving space has a material mixing chamber, a mixing rod, and an anti-leaking ball valve.
